(19) United States
(12) Patent Application Publication
(10) Pub. No.: US 2016/0188244 A1
(43) Pub. Date: Jun. 30, 2016

(54) Apparatus and method for providing security for memory in electronic device

(71) Applicant: Samsung Electronics Co., Ltd., Gyeonggi-do (KR)

(72) Inventors: Seungjin Yang, Gyeonggi-do (KR); Gilyoon Kim, Gyeonggi-do (KR)

(21) Appl. No.: 14/998,160

(22) Filed: Dec. 24, 2015

(30) Foreign Application Priority Data
Dec. 24, 2014 (KR) 10-2014-0188266

(51) Int. Cl. G06F 3/06

(52) U.S. Cl. CPC G06F 3/0622; G06F 3/064; G06F 3/067

(57) ABSTRACT

A method of operating an electronic device includes storing access authority information indicating whether access to each of memory units of at least one access-restricted region from among a plurality of regions in a storage space is allowed or not. The method further includes, when an access request to the at least one access-restricted region is generated, determining whether to allow access based on the access authority information.

### CROSS-REFERENCE TO RELATED APPLICATIONS AND CLAIM OF PRIORITY

The present application is related to and claims benefit under 35 U.S.C. §119 to an application filed in the Korean Intellectual Property Office on Dec. 24, 2014 and assigned Serial No. 10-2014-0188266, the contents of which are incorporated herein by reference.

### TECHNICAL FIELD

Exemplary embodiments of the present disclosure relate to securing a memory in an electronic device.

### BACKGROUND

With the development of telecommunication technology, widespread use of user equipment has increased dramatically. In addition, as the use of user equipment increases, there is an increasing demand for security for the user equipment. A security refers to preventing unauthorized users from using data or programs. In particular, a security for a memory page is important to a user equipment. The memory page refers to a region of a certain size which is divided from a memory region in a virtual storage device. For example, the memory page may be a memory block of various sizes (such as 2 KB, 4 KB, 1 MB). Each of the memory pages may be formed of a single block of a continuous logical address, and the single block may be used as a single unit. Through the single block, data is transmitted between a real storage device and a secondary storage device.

### SUMMARY

To address the above-discussed deficiencies, it is a primary object to provide at least the advantages described below. Accordingly, an aspect of the present disclosure provides an apparatus and method for generating information indicating whether access to each of the memory units (such as a page unit or a block unit) of access-restricted regions from among a plurality of regions in a memory is allowed or not.

Another aspect of the present disclosure provides an apparatus and method which, when an access request to at least one of the memory units of access-restricted regions is generated, determines whether to allow the access or not based on information indicating whether access to each of the memory units of the access-restricted regions is allowed or not.

Another aspect of the present disclosure provides an apparatus and method for generating information indicating whether access to each of the memory units of a plurality of regions in a memory is allowed or not.

According to an aspect of the present disclosure, an electronic device includes: a memory configured to store access authority information indicating whether access to each of memory units of at least one access-restricted region from among a plurality of regions in a storage space is allowed or not; and a logic configured to, when an access request to the at least one access-restricted region is generated, determine whether to allow access based on the access authority information.

According to another aspect of the present disclosure, an operation method of an electronic device includes: storing access authority information indicating whether access to each of memory units of at least one access-restricted region from among a plurality of regions in a storage space is allowed or not; and, when an access request to the at least one access-restricted region is generated, determining whether to allow access based on the access authority information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example configuration of a memory;

FIG. 2 illustrates examples of a memory management unit (MMU) method, a bus monitor method, and a trust zone method;

FIG. 3 illustrates an example network environment 300 including an electronic device 301 according to various exemplary embodiments of the present disclosure;

FIG. 4 illustrates an example configuration of an electronic device according to various exemplary embodiments of the present disclosure;

FIG. 5 illustrates an example of controlling traffic trying to access a memory in an electronic device according to various exemplary embodiments of the present disclosure;

FIGS. 6A to 6C illustrate an example of dividing a memory region into a plurality of memory page units in an electronic device according to various exemplary embodiments of the present disclosure;

FIGS. 7A to 7D illustrate an example of controlling traffic requesting access to a memory in an electronic device according to various exemplary embodiments of the present disclosure;

FIG. 8 illustrates an example of, when traffic requesting access to a memory is generated in an electronic device, determining whether the traffic is allowed to access the memory according to various exemplary embodiments of the present disclosure;

FIG. 9 illustrates an example operation sequence when traffic trying to access a write protectable region of a memory region is generated in an electronic device according to various exemplary embodiments of the present disclosure;

FIG. 10 illustrates another example operation sequence when traffic trying to access a security protectable region of a memory region is generated in an electronic device according to various exemplary embodiments of the present disclosure; and

FIG. 11 illustrates another example operation sequence of an electronic device according to various exemplary embodiments of the present disclosure.

### DETAILED DESCRIPTION

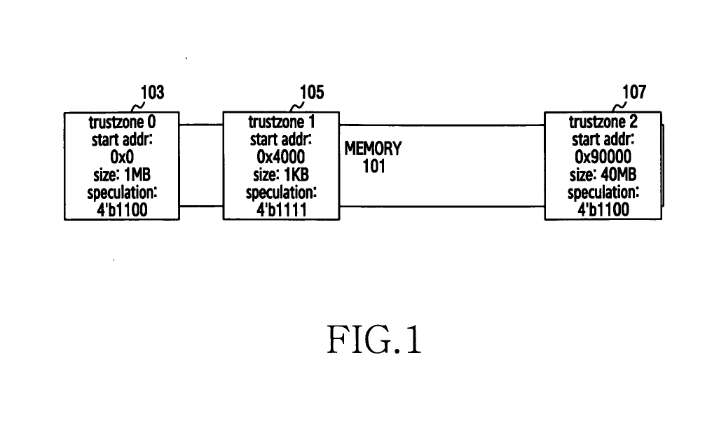

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Exemplary embodiments of the present disclosure will be described herein below with reference to the accompanying drawings. In the following description, detailed descriptions of well-known functions or configurations will be omitted since they would unnecessarily obscure the subject matters of the present disclosure. Also, the terms used herein are defined according to the functions of the present disclosure. Thus, the terms may vary depending on users' or operators' intentions or practices. Therefore, the terms used herein should be understood based on the descriptions made herein.

Exemplary embodiments of the present disclosure will be described herein below with reference to the accompanying drawings. Although specific embodiments of the present disclosure are illustrated in the drawings and relevant detailed descriptions are provided, various changes can be made and various exemplary embodiments may be provided. Accordingly, the various exemplary embodiments of the present disclosure are not limited to the specific embodiments and should be construed as including all changes and/or equivalents or substitutes included in the ideas and technological scopes of the exemplary embodiments of the present disclosure. In the explanation of the drawings, similar reference numerals are used for similar elements.

The terms “include” or “may include” used in the exemplary embodiments of the present disclosure indicate the presence of disclosed corresponding functions, operations, elements, and the like, and do not limit additional one or more functions, operations, elements, and the like. In addition, it should be understood that the terms “include” or “has” used in the exemplary embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The term “or” or “at least one of A or/and B” used in the exemplary embodiments of the present disclosure include any and all possible combinations of words enumerated with them. For example, “A or B” or “at least one of A or/and B” mean including A, including B, or including both A and B.

The terms such as “first” and “second” used in the various exemplary embodiments of the present disclosure may modify various elements of various exemplary embodiments, and does not limit the corresponding elements. For example, these terms do not limit the order and/or importance of the corresponding elements. These terms may be used for the purpose of distinguishing one element from another element. For example, a first user device and a second user device all indicate user devices and may indicate different user devices. For example, a first element may be named a second element without departing from the scope of right of the various exemplary embodiments of the present disclosure, and similarly, a second element may be named a first element.

It will be understood that when an element is “connected” or “coupled” to another element, the element may be directly connected or coupled to another element, and there may be an intervening element between the element and another element. To the contrary, it will be understood that when an element is “directly connected” or “directly coupled” to another element, there is no intervening element between the element and another element.

The terms used in the various exemplary embodiments of the present disclosure are for the purpose of describing particular exemplary embodiments only and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having ideal or exaggerated meanings unless they are clearly defined in the various exemplary embodiments.

An electronic device according to various exemplary embodiments of the present disclosure may be a device which is equipped with a communication function. For example, the electronic device may include at least one of a smartphone, a tablet personal computer (PC), a mobile phone, a video phone, an electronic book reader, a desktop PC, a laptop PC, a netbook computer, a personal digital assistant (PDA), a portable multimedia player (PMP), an MP3 player, a mobile medical machine, a camera, or a wearable device (such as a head-mounted-device (HMD) such as electronic glasses, electronic clothing, an electronic bracelet, an electronic necklace, an electronic appccessory, electronic tattoos, or a smartwatch).

According to an exemplary embodiment, the electronic device may be a smart home appliance which is equipped with a communication function. For example, the smart home appliance may include at least one of a television, a digital video disk (DVD) player, a stereo, a refrigerator, an air conditioner, a cleaner, an oven, a microwave oven, a washing machine, an air cleaner, a set-top box, a TV box (such as Samsung HomeSync™, Apple TV™, or Goggle TV™), a game console, an electronic dictionary, an electronic key, a camcorder, or an electronic album.

According to an exemplary embodiment, the electronic device may include at least one of various medical machines (such as magnetic resonance angiography (MRA), magnetic resonance imaging (MRI), computerized tomography (CT), a tomograph, an ultrasound machine, and the like), a navigation device, a global positioning system (GPS) receiver, an event data recorder (EDR), a flight data recorder (FDR), an automotive infotainment device, electronic equipment for ship (such as navigation equipment for ship, a gyro compass, and the like), avionics, a security device, a head unit for vehicles, an industrial or home robot, an automatic teller machine (ATM) of a financial institution, or point of sales (POS) of a store.

According to an exemplary embodiment, the electronic device may include at least one of a part of furniture or a building/a structure equipped with a communication function, an electronic board, an electronic signature receiving device, a projector, and various measurement devices (such as water, power, gas, or radio waves measurement devices). The electronic device according to various exemplary embodiment of the present disclosure may be one or a combination of one or more of the above-mentioned devices. In addition, the electronic device according to various exemplary embodiments of the present disclosure may be a flexible device. In addition, it is obvious to an ordinary skilled person in the related art that the electronic device according to various exemplary embodiments of the present disclosure is not limited to the above-mentioned devices.

Hereinafter, an electronic device according to various exemplary embodiments will be explained with reference to the accompanying drawings. The term “user” used in various exemplary embodiments may refer to a person who uses the electronic device or a device which uses the electronic device (for example, an artificial intelligence electronic device).

Hereinafter, technology for securing a memory in an electronic device according to exemplary embodiments of the present disclosure will be explained.

FIG. 1 illustrates an example of a configuration of a memory 100. Referring to FIG. 1, the trust zone method sets a plurality of regions 103-107 for a memory 101, and, when memory access to at least one of the plurality of regions 103-107 occurs, determines whether the memory access is authorized to access or not. For example, in the trust zone method, when the access is not authorized to access, the access may be blocked and a notification may be transmitted to a system. For example, the plurality of regions 103-107 may be set as a start address region, an end address region, an authority setting region (such as secure write, secure read, normal write, and normal read), etc. Since the trust zone method clearly indicates the start address and the end address in the memory 101, the trust zone method may require memory reservation in order to guarantee a continuous memory. The trust zone method may manage access authority with a specific size at a specific start address of the memory 101. The trust zone method may determine whether certain traffic is traffic accessing at least one of the plurality of regions 103-107 or the traffic has authority to access at least one of the plurality of regions 103-107.

To apply the trust zone method, the plurality of regions 103-107 may occupy a continuous space in the memory 101. In addition, the number of the plurality of regions 103-107 is limited. Therefore, since the trust zone method may set the plurality of regions 103-107 as trust zones in some continuous regions of the memory 101, the trust zone method requires the memory reservation for some continuous regions of the memory 101. The memory reserved for the sake of the trust zone may not be used for other purposes, and for example, it may be difficult to dynamically reset the size of the region when the system is driven. The MMU method refers to a method in which the MMU controls accesses to the respective memory pages based on a memory page table, in which access authority information on the respective memory pages are inputted.

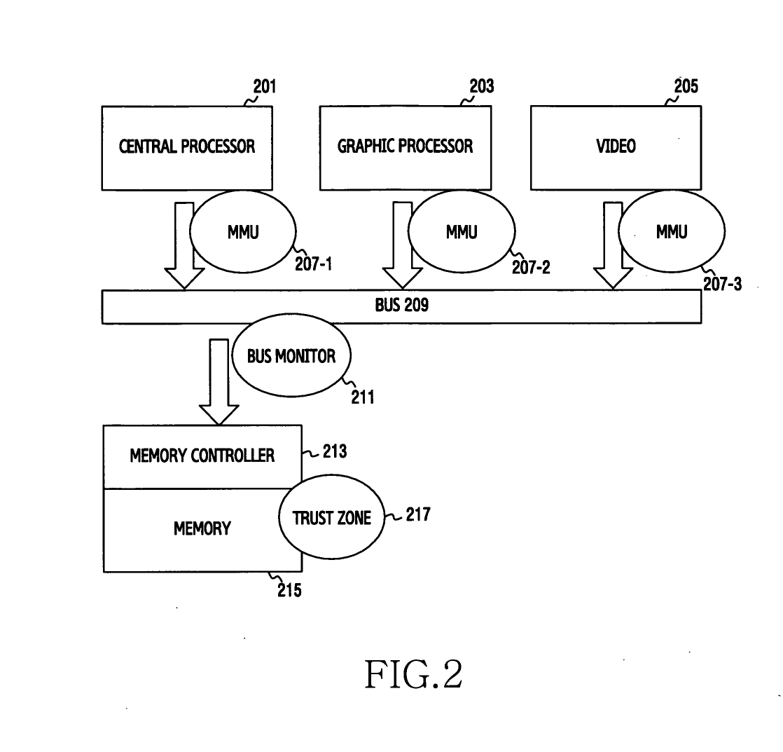

FIG. 2 illustrates examples of a MMU method, bus monitor method, and trust zone method 200. Referring to FIG. 2, when traffic to access a memory is generated from at least one of a central processor 201, a graphic processor 203, and a video 205, the MMUs 207-1 to 207-3 may determine whether the traffic has authority to access the memory or not based on the memory page table, and control the traffic. In the MMU method, the MMU, which is a hardware logic of a big size, may be located in a master intellectual property (IP), and, when an MMU page miss frequently occurs, a system performance may deteriorate. In addition, in the MMU method, the MMU may be included in every bus monitor.

The bus monitor method refers to a method in which, a bus monitor, which contains information on a memory region loaded with important data and not requiring writing like a linux kernel module (LKM), monitors whether memory writing is performed on the memory region loaded with the important data in a bus. For example, referring to FIG. 2, when writing occurs on the memory 215 region loaded with the important data, the bus monitor 211 may identify the occurrence of the writing. The bus monitor 211 may determine whether the writing is normal access or abnormal access, and control the writing according to whether the writing is normal access or abnormal access. However, the bus monitor method determines whether corresponding access is normal or abnormal after accessing the memory, and can monitor only a specific address region due to the processing capability of the monitoring.

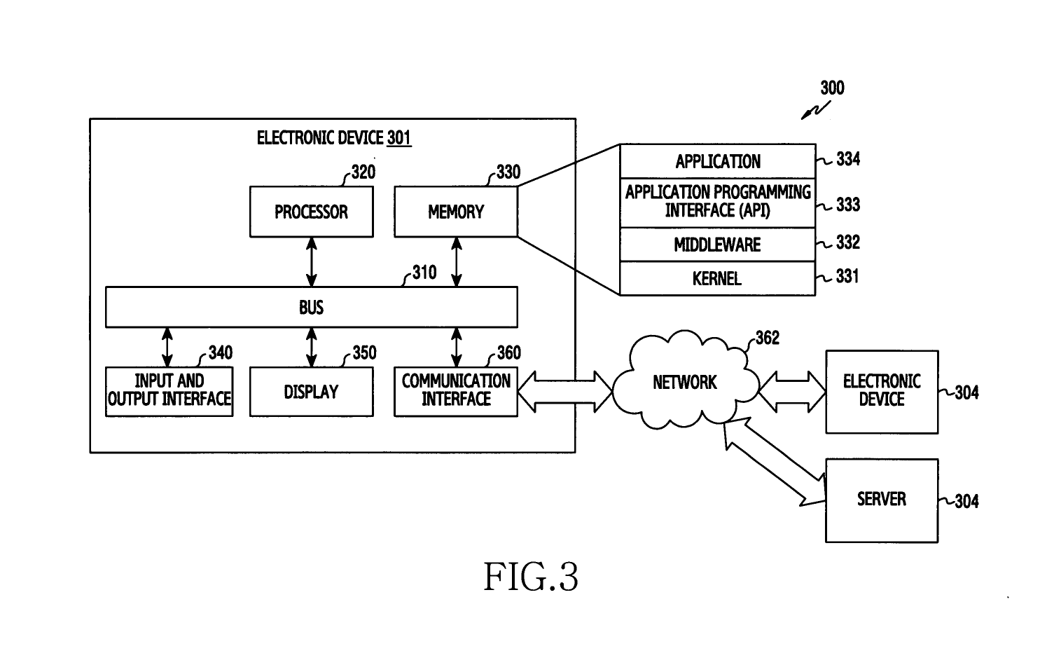

FIG. 3 illustrates an example network environment 300 including an electronic device 301 according to the present disclosure.

Referring to FIG. 3, the electronic device 301 may include a bus 310, a processor 320, a memory 330, an input and output interface 340, a display 350, and a communication interface 360.

The bus 310 may be a circuit which connects the above-described elements with one another and transmits communication (for example, a control message) between the above-described elements.

The processor 320 may receive instructions from the other elements (for example, the memory 330, the input and output interface 340, the display 350, the communication interface 360, and the like) via the bus 310, decipher the instructions, and perform calculation or data processing according to the deciphered instructions.

According to an exemplary embodiment of the present disclosure, the electronic device 301 may further include a memory controller (not shown). The memory controller (not shown) may determine whether to allow access or not based on the access authority information when a request to access at least one access-restricted region is generated. The access request may include a display indicating that the intention of the access request is for at least one of secure read, secure write, normal read, and normal write on the at least one memory unit, and an address of a memory unit that the access request tries to access. When the memory unit to which the access request is generated is a memory unit disallowing the intention of the access request, the memory controller (not shown) may block the access request. When a change to the access authority information is requested, the memory controller (not shown) may change the access authority information. When a request to access an access-restricted region restricting at least one of read and write is generated, the memory controller (not shown) may determine whether to allow the access to the access-restricted region restring the read and the write based on the access authority information. The memory controller (not shown) may be named a logic.

The memory 330 may store instructions or data which is received from or generated by the processor 320 or the other elements (for example, the input and output interface 340, the display 350, the communication interface 360, and the like). For example, the memory 330 may store programming modules such as a kernel 331, middleware 332, an Application Programming Interface (API) 333, an application 334, and the like. Each of the above-described programming modules may be configured by software, firmware, hardware, or a combination of two or more of them.

In addition the typical functions, the memory 330 according to an exemplary embodiment of the present disclosure may store access authority information indicating whether access to each of memory units of at least one access-restricted region from among a plurality of regions in a storage space is allowed or not. The access authority information may include at least one table for each of the at least one access-restricted region. Each of the at least one table may indicate whether at least one of secure read, secure write, normal read, and normal write is allowed or not for each of the memory units. The memory 330 may store the access authority information in the at least one access-restricted region. According to an exemplary embodiment of the present disclosure, the table refers to a set of pieces of memory access authority information, and may have access authority information for a memory unit corresponding to a bit unit. The electronic device 301 can minimize a space for storing the access authority information through the table structure, and also, can identify the access information in real time. According to an exemplary embodiment of the present disclosure, the table is not limited to a form of a specific material structure.

The kernel 331 may control or manage system resources (for example, the bus 310, the processor 320, the memory 330, and the like) which are used for performing operations or functions implemented in the other programming modules, for example, the middleware 332, the API 333, or the application 334. In addition, the kernel 131 may provide an interface for allowing the middleware 332, the API 333, or the application 334 to access an individual element of the electronic device 301 and control or manage the element.

The middleware 332 may serve as an intermediary to allow the API 333 or the application 334 to communicate with the kernel 331 and exchange data with the kernel 331. In addition, the middleware 332 may perform controlling (for example, scheduling or load balancing) with respect to work requests received from the application 134, for example, by giving priority to use the system resources of the electronic device 301 (for example, the bus 310, the processor 320, the memory 330, and the like) to at least one of the applications 134.

The API 333 is an interface for allowing the application 334 to control a function provided by the kernel 331 or the middleware 334, and, for example, may include at least one interface or function (for example, instructions) for controlling a file, controlling a window, processing an image, or controlling a text.

According to various exemplary embodiments, the application 334 may include a Short Message Service (SMS)/Multimedia Messaging Service (MMS) application, an email application, a calendar application, an alarm application, a health care application (for example: an application for measuring exercise or a blood glucose), an environment information application (for example: an application for providing information on atmospheric pressure, humidity, or temperature), and the like. Additionally or alternatively, the application 334 may be an application related to information exchange between the electronic device 301 and an external electronic device (for example: an electronic device 304). For example, the application related to the information exchange may include a notification relay application for relaying specific information to the external electronic device or a device management application for managing the external electronic device.

For example, the notification relay application may include a function of relaying notification information generated by other applications of the electronic device 301 (for example: the SMS/MMS application, the email application, the health care application, the environment information application, and the like) to an external electronic device (for example: the electronic device 304). Additionally or alternatively, the notification relay application may receive notification information from the external electronic device (for example: the electronic device 304) and may relay the same to the user. For example, the device management application may manage (for example: install, delete or update) a function regarding at least part of the external electronic device (for example: the electronic device 304) communicating with the electronic device 301 (for example: turning on/off the external electronic device (or some parts) or adjusting brightness of a display), an application operating in the external electronic device or a service provided by the external electronic device (for example: a calling service or a message service).

According to various exemplary embodiments, the application 334 may include an application specified according to an attribute (for example: a kind of an electronic device) of the external electronic device (for example: the electronic device 304). For example, when the external electronic device is an MP3 player, the application 334 may include an application related to music replay. Similarly, when the external electronic device is a mobile medical device, the application 334 may include an application related to health care. According to an exemplary embodiment, the application 334 may include at least one of an application specified by the electronic device 301 or an application received from the external electronic device (for example: a server 306 or the electronic device 304).

The input and output interface 340 may transmit instructions or data input by the user through an input and output device (for example: a sensor, a keyboard, or a touch screen) to the processor 320, the memory 330, or the communication interface 360 through the bus 310, for example. For example, the input and output interface 340 may provide data on a user's touch input through a touch screen to the processor 320. In addition, the input and output interface 340 may output instructions or data received from the processor 320, the memory 330, or the communication interface 360 through the bus 310 through the input and output device (for example: a speaker or a display). For example, the input and output interface 340 may output audio data processed by the processor 320 to the user through a speaker.

The display 350 may display a variety of information (for example: multimedia data, text data, and the like) for the user.

The communication interface 360 may connect communication between the electronic device 301 and the external device (for example: the electronic device 304 or the server 306). For example, the communication interface 360 may be connected to a network 362 via wireless communication or wire communication to communicate with the external device. The wireless communication may include at least one of Wireless Fidelity (WiFi), Bluetooth (BT), Near Field Communication (NFC), Global Positioning System (GPS), or cellular communication (for example: LTE, LTE-A, CDMA, WCDMA, UMTS, WiBro, GSM, and the like). The wire communication may include at least one of a Universal Serial Bus (USB), a High Definition Multimedia Interface (HDMI), a Recommended Standard 232 (RS-232), or a Plain Old Telephone Service (POTS).

According to an exemplary embodiment, the network 362 may be a telecommunications network. The telecommunications network may include at least one of a computer network, the Internet, Internet of things, or a telephone network. According to an exemplary embodiment, a protocol for communicating between the electronic device 301 and the external device (for example: a transport layer protocol, a data link layer protocol or a physical layer protocol) may be supported in at least one of the application 334, the application programming interface 333, the middleware 332, the kernel 331, or the communication interface 360.

According to an exemplary embodiment, the server 306 may support the driving of the electronic device 301 by performing at least one of the operations (or functions) implemented in the electronic device 301.

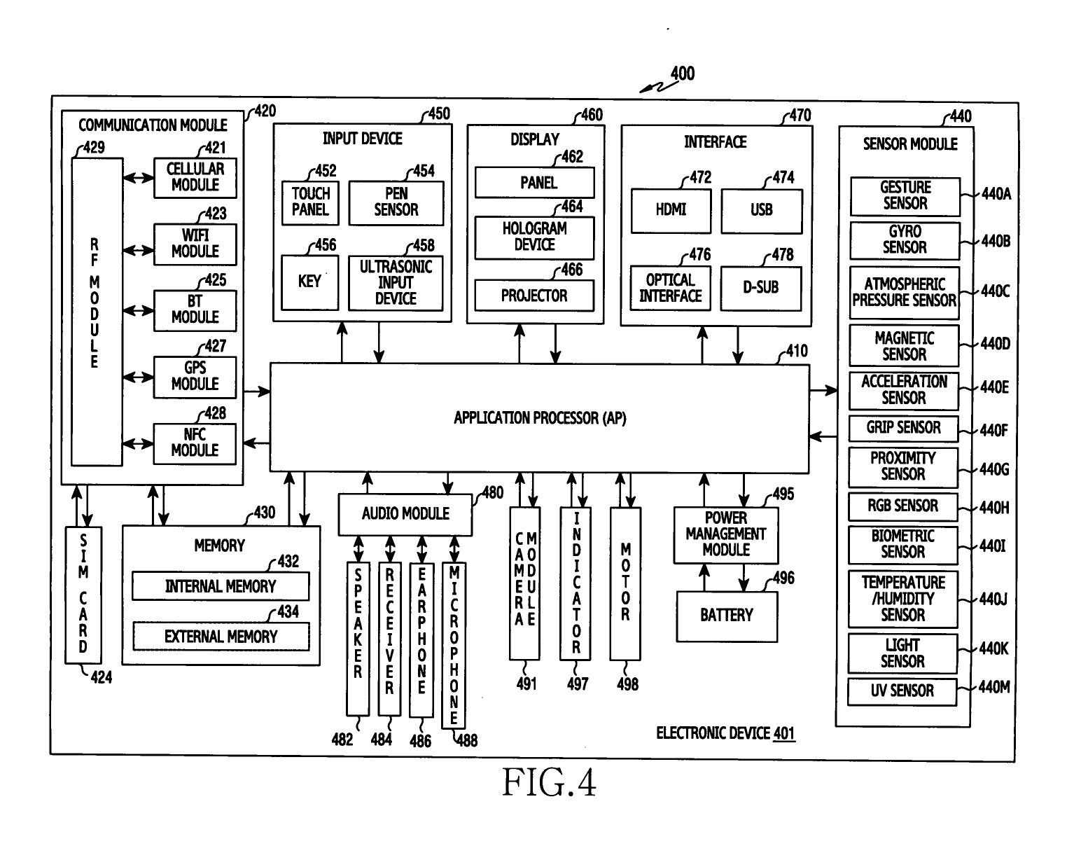

FIG. 4 illustrates an example block diagram of an electronic device 401 according to an embodiment of the present disclosure.

Referring to FIG. 4, the electronic device 401 may include one or more processors 410 (for such as an application processor (AP)), a communication module 420, a subscriber identification module (SIM) card 424, a memory 430, a sensor module 440, an input device 450, a display 460, an interface 470, an audio module 480, a camera module 491, a power management module 495, a battery 496, an indicator 497, and a motor 498.

The processor 410 may control a plurality of hardware or software elements connected to the processor 410 by driving an operating system or an application program, and may process and calculate various data. For example, the processor 410 may be implemented by using a system on chip (SoC). The processor 410 may further include a graphic processing unit (GPU) and/or an image signal processor. The processor 410 may include at least part of the elements shown in FIG. 4 (for example, the cellular module 421). The processor 410 may load instructions or data received from at least one of the other elements (for example, a non-volatile memory) into a volatile memory and process the instructions or data, and may store various data in the non-volatile memory.

According to an exemplary embodiment of the present disclosure, the electronic device 401 may further include a memory controller (not shown). The memory controller (not shown) may determine whether to allow access or not based on the access authority information when a request to access at least one access-restricted region is generated. The access request may include a display indicating that the intention of the access request is for at least one of secure read, secure write, normal read, and normal write on the at least one memory unit, and an address of a memory unit that the access request tries to access. When the memory unit to which the access request is generated is a memory unit disallowing the intention of the access request, the memory controller (not shown) may block the access request and transmit block information to system. When a change to the access authority information is requested, the memory controller (not shown) may change the access authority information. When a request to access an access-restricted region restricting at least one of read and write is generated, the memory controller (not shown) may determine whether to allow the access to the access-restricted region restring the read and the write based on the access authority information.

The communication module 420 may have a same or similar configuration as that of the communication interface 360 of FIG. 3. For example, the communication module 420 may include the cellular module 421, a Wireless Fidelity (WiFi) module 423, a Bluetooth (BT) module 425, a Global Positioning System (GPS) module 427, a near field communication (NFC) module 428, and a Radio Frequency (RF) module 429.

The cellular module 421 may provide a voice call, a video call, a text service, or an Internet service through a telecommunications network. The cellular module 421 may identify and authenticate the electronic device 401 in the telecommunications network by using the SIM card 424. The cellular module 421 may perform at least some of the functions provided by the processor 410. The cellular module 421 may include a communication processor (CP).

The WiFi module 423, the BT module 425, the GPS module 427, and the NFC module 428 each may include a processor for processing data received and transmitted through a corresponding module. At least some (for example, two or more) of the cellular module 421, the WiFi module 423, the BT module 425, the GPS module 427, and the NFC module 428 may be included in a single integrated chip (IC) or a single IC package.

The RF module 429 may transmit and receive communication signals, such as an RF signal. For example, the RF module 429 may include a transceiver, a power amp module (PAM), a frequency filter, a Low Noise Amplifier (LNA), an antenna, etc. At least one of the cellular module 421, the WiFi module 423, the BT module 425, the GPS module 427, and the NFC module 428 may transmit and receive an RF signal through a separate RF module.

The SIM card 424 may include an embedded SIM including the subscriber identification module, and may include its unique identification information (for example, an Integrated Circuit Card Identifier (ICCID)) or subscriber information (for example, International Mobile Subscriber Identity (IMSI)).

The memory 430 (or memory 330) may include an internal memory 432 or an external memory 434. The internal memory 432 may include at least one of a volatile memory (for example, a Dynamic Random Access Memory (DRAM), a Static Random Access Memory (SRAM), a Synchronous DRAM (SDRAM), and the like) and a non-volatile memory (for example, an One-Time Programmable Read Only Memory (OTPROM), a Programmable Read Only Memory (PROM), an Erasable Programmable Read Only Memory (EPROM), an Electrically Erasable Programmable Read Only Memory (EEPROM), a mask ROM, a flash ROM, a flash memory (for example, a NAND flash memory, a NOR flash memory, and the like), a hard drive, a solid state drive (SSD).

The external memory 434 may further include a flash drive, for example, Compact Flash (CF), Secure Digital (SD), Micro-SD, Mini-SD, extreme-Digital (xD), a Multi Media Card (MMC), memory stick, and the like. The external memory 434 may be functionally and/or physically connected with the electronic device 401 through various interfaces.

In addition the typical functions, the memory 430 according to an exemplary embodiment of the present disclosure may store access authority information indicating whether access to each of memory units of at least one access-restricted region from among a plurality of regions in a storage space is allowed or not. The access authority information may include at least one table for each of the at least one access-restricted region. Each of the at least one table may indicate whether at least one of secure read, secure write, normal read, and normal write is allowed or not for each of the memory units. The memory 430 may store the access authority information in the at least one access-restricted region. According to an exemplary embodiment of the present disclosure, the access authority information is saved at least one of internal memory 432 or external memory 434.

The sensor module 440 may measure a physical quantity or detect an operation state of the electronic device 401, and may convert measured or detected information into electric signals. The sensor module 440 may include at least one of a gesture sensor 440A, a gyro sensor 440B, a barometric pressure sensor 440C, a magnetic sensor 440D, an acceleration sensor 440E, a grip sensor 440F, a proximity sensor 440G, a color sensor 440H (e.g., Red, Green, Blue (RGB) sensor), a biosensor 440I, a temperature/humidity sensor 440J, an illumination sensor 440K, and an Ultraviolet (UV) sensor 440M. Additionally or alternatively, the sensor module 440 may include an E-nose sensor, an electromyography (EMG) sensor, an electroencephalogram (EEG) sensor, an electrocardiogram (ECG) sensor, an infrared ray (IR) sensor, an iris sensor, and/or a fingerprint sensor, and the like. The sensor module 440 may further include a control circuit to control at least one sensor included therein. The electronic device 401 may further include a processor configured to control the sensor module 440 as a part of the processor 410 or a separate part, and may control the sensor module 440 while the processor 410 is in a sleep state.

The input device 450 may include a touch panel 452, a (digital) pen sensor 454, a key 456, or an ultrasonic input device 458. The touch panel 452 may use at least one of capacitive, resistive, infrared, and ultrasonic methods. In addition, the touch panel 452 may further include a control circuit. The touch panel 452 may further include a tactile layer to provide a tactile response to the user.

The (digital) pen sensor 454 may be a part of the touch panel or may include a separate detection sheet. The key 456 may include a physical button, an optical key, or a keypad. The ultrasonic input device 458 may detect ultrasonic waves generated in an input tool through a microphone 488, and identify data corresponding to the detected ultrasonic waves.

The display 460 (or display 350) may include a panel 462, a hologram device 464, or a projector 466. The panel 462 may have a same or similar configuration as or to that of the display 350 of FIG. 3. For example, the panel 462 may be implemented to be flexible, transparent, or wearable. The panel 462 may be configured as a single module along with the touch panel 452. The hologram device 464 may show a stereoscopic image in the air using interference of light. The projector 466 may display an image by projecting light onto a screen or surface. The screen may be located inside or outside the electronic device 401. The display 460 may further include a control circuit to control the panel 462, the hologram device 464, or the projector 466.

The interface 470 may include a High Definition Multimedia Interface (HDMI) 472, a Universal Serial Bus (USB) 474, an optical interface 476, or D-subminiature (sub) 478. The interface 470 may be included in the communication interface 360 shown in FIG. 3. Additionally or alternatively, the interface 470 may include a Mobile High Definition Link (MHL) interface, a Secure Digital (SD) card/Multimedia Card (MMC) interface or Infrared Data Association (IrDA) standard interface.

The audio module 480 may convert a sound and an electric signal bi-directionally. For example, at least some elements of the audio module 480 may be included in the input and output interface 340 shown in FIG. 3. The audio module 480 may process sound information which is input or output through a speaker 482, a receiver 484, an earphone 486, or the microphone 488.

The camera module 491 is a device for photographing a still image and a moving image, and according to an embodiment of the present disclosure, the camera module 491 may include one or more image sensors (such as a front surface sensor or a rear surface sensor), a lens, an image signal processor (ISP), or a flash (such as a light emitting diode (LED) or a xenon lamp).

The power management module 495 may manage power of the electronic device 401. According to an exemplary embodiment, the power management module 495 may include a Power Management IC (PMIC), a charger IC, or a battery gauge. For example, the PMIC may utilize a wire charging method and/or a wireless charging method. The wireless charging method may include a magnetic resonance method, a magnetic induction method, or an electromagnetic wave method, and an additional circuit for charging wirelessly, for example, a coil loop, a resonant circuit, a rectifier, and the like may be added. For example, the battery gauge may measure a remaining battery life of the battery 496, a voltage, a current, or temperature during charging. The battery 496 may include a rechargeable battery and/or a solar battery.

The indicator 497 may display a specific state of the electronic device 401 or a part of it (for example, the processor 410), for example, a booting state, a message state, or a charging state. The motor 498 may convert an electric signal into a mechanical vibration, and cause a vibration or haptic effect. Although not shown, the electronic device 401 may include a processing device (for example, a GPU) for supporting a mobile TV. The processing device for supporting the mobile TV may process media data according to standards such as Digital Multimedia Broadcasting (DMB), Digital Video Broadcasting (DVB), or media flow.

Each of the above-described elements of the electronic device according to various embodiments of the present disclosure may be comprised of one or more components, and the names of the elements may vary according to the kind of the electronic device. The electronic device according to various embodiments of the present disclosure may include at least one of the above-described elements, and some of the elements may be omitted or an additional element may be further included. In addition, some of the elements of the electronic device may be combined into a single entity, and may perform the same functions as those of the elements before being combined.

According to various exemplary embodiments of the present disclosure, an electronic device may include: a memory configured to store access authority information indicating whether access to each of memory units of at least one access-restricted region from among a plurality of regions in a storage space is allowed or not; and a logic (such as memory controller) configured to, when an access request to the at least one access-restricted region is generated, determine whether to allow access based on the access authority information.

According to various exemplary embodiments of the present disclosure, the access authority information may include at least one table for each of the at least one access-restricted region, and each of the at least one table may indicate whether at least one of secure read, secure write, normal read, and normal write is allowed on each of the memory units.

According to various exemplary embodiments of the present disclosure, the access request may include a display indicating that the access request has an intention of performing at least one of secure read, secure write, normal read, and normal write on the at least one memory unit, and an address of a memory unit that the access request tires to access.

According to various exemplary embodiments of the present disclosure, when the memory unit to which the access request is generated is a memory unit which does not allow the intention of the access request, the logic (such as memory controller) may block the access request.

According to various exemplary embodiments of the present disclosure, when a change to the access authority information is requested, the logic (such as memory controller) may change the access authority information.

According to various exemplary embodiments of the present disclosure, the memory may store the access authority information in the at least one access-restricted region.

According to various exemplary embodiments of the present disclosure, the at least one access-restricted region may include a region which restricts at least one of read and write.

According to various exemplary embodiments of the present disclosure, when an access request to the region restricting at least one of the read and the write is generated, the logic (such as memory controller) may determine whether to allow the access based on the access authority information.

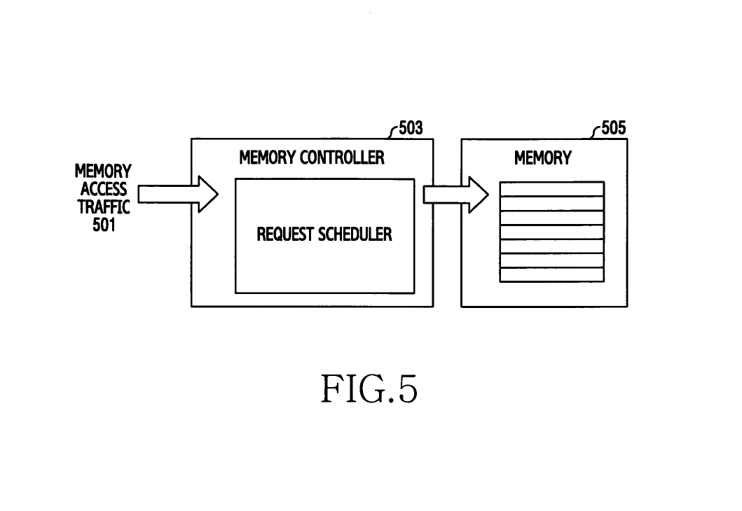

FIG. 5 illustrates an example of controlling traffic trying to access a memory in an electronic device according to the present disclosure.

Referring to FIG. 5, when at least one piece of traffic 501 trying to access a memory 505 is generated, the electronic device may control the traffic 501 through a memory controller 503. For example, the electronic device may divide the memory 505 into a plurality of regions including at least one security region. The electronic device may divide the at least one security region into a plurality of memory page units. The electronic device may determine whether to allow access to each of the plurality of memory page units. The electronic device may generate information on whether access is allowed or not. When at least one piece of traffic trying to access at least one of the plurality of memory units of the memory 505 is generated, the memory controller 503 may determine whether the at least one memory unit is allowed to be accessed or not based on the information on whether the access is allowed or not. When the at least one memory unit is not allowed to be accessed, the memory controller 503 may block the traffic.

In the specification, the memory page units are explained according to an exemplary embodiment of the present disclosure. However, this is merely an example and should not be interpreted as limiting the present disclosure. For example, according to another exemplary embodiment of the present disclosure, the memory may be formed of memory units of a certain type other than the page units without departing from the scope of the present disclosure.

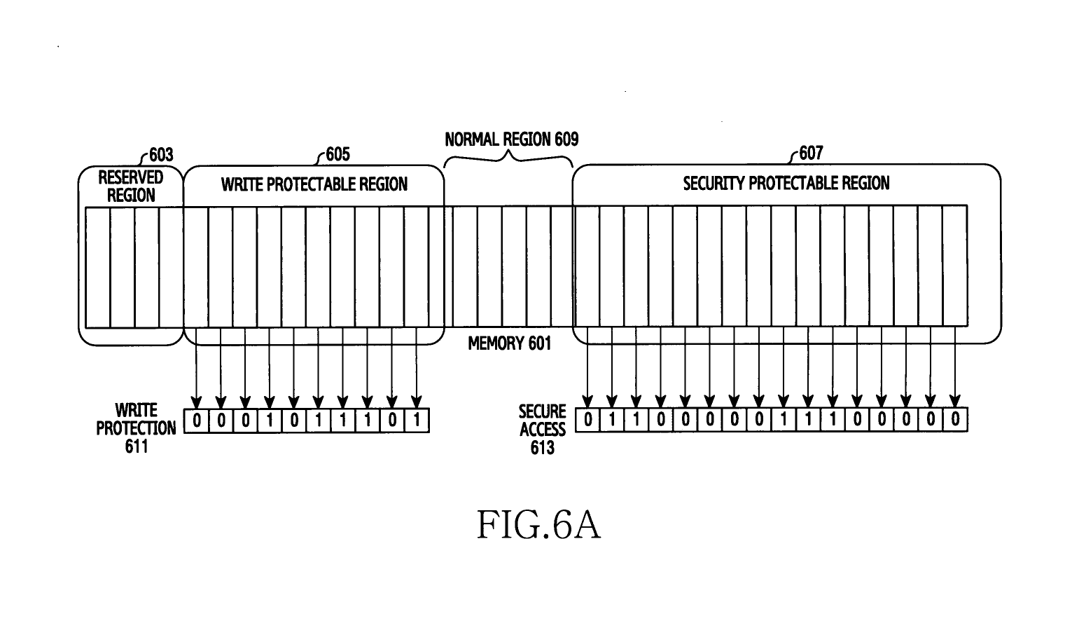

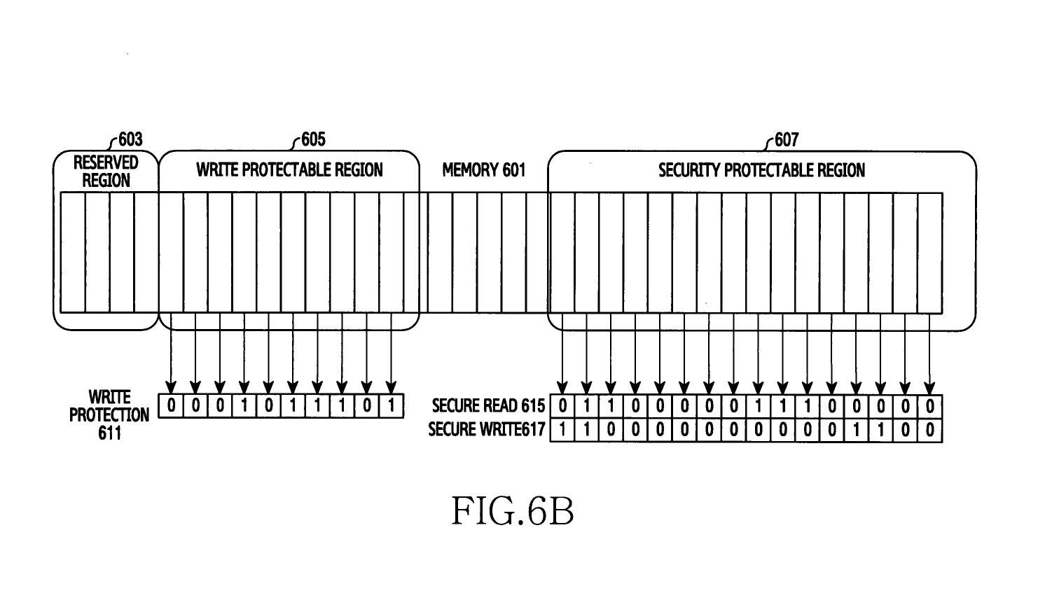

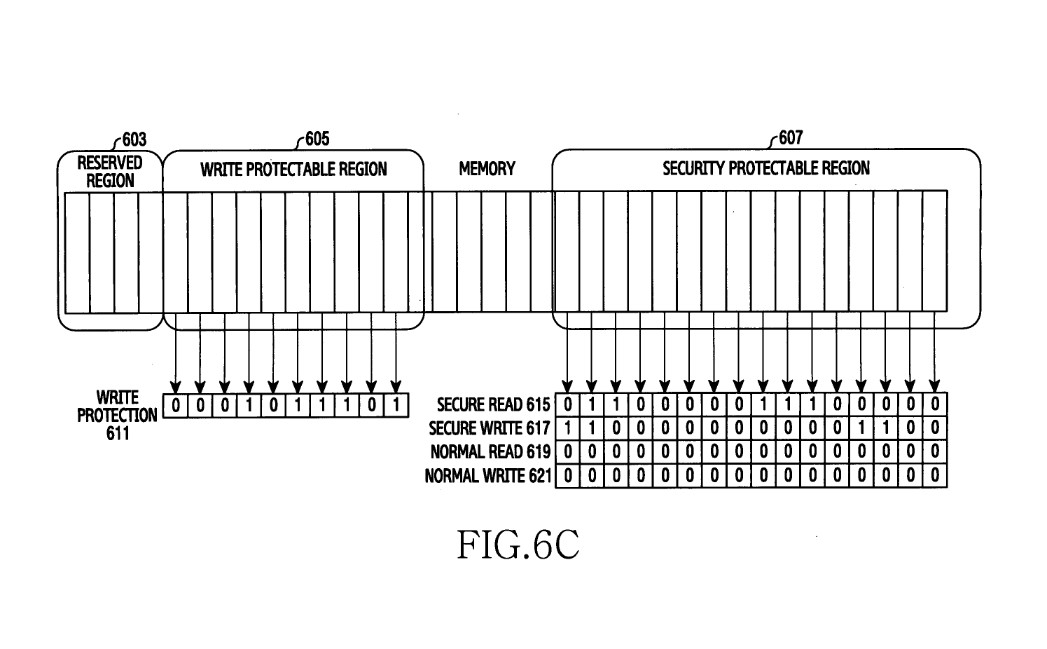

FIGS. 6A to 6C illustrate an example of dividing a memory region into a plurality of memory page units in the electronic device according to an exemplary embodiment of the present disclosure.

Referring to FIG. 6A, the electronic device may divide a memory 601 into a reserved region 603, a write protectable region 605, a security protectable region 607, and a normal region 609 which does not require security. The electronic device may divide the write protectable region 605 and the security protectable region 607 into a plurality of memory pages.

For example, in a Linux system, the memory 601 may be divided into a reserved memory region 603, protectable memory regions 605, 607, and a normal memory region 609. In addition, since each of the above-mentioned regions is reserved and used in the unit of a page, attributes may be allocated to memory blocks in the unit of a block in each of the above-mentioned regions.

The electronic device according to an exemplary embodiment of the present disclosure may have a start address indicating to which address of the memory 601 a bit stream may be applied first. Herein, the bit stream indicates whether reading or writing on the memory 601 is allowed or not. For example, the electronic device may determine information on the start address of the write protectable region 605 or the security protectable region 607 in advance.

The electronic device may set whether to allow access to each of the plurality of memory pages of the write protectable region 605 and the security protectable region 607. For example, when the write protectable region 605 is formed of a plurality of memory pages, the electronic device may define a write protection table 611 indicating whether writing is allowed on each of the plurality of memory pages. For example, the electronic device may generate the write protection table 611 including 10 values indicating whether writing is allowed on each of the 10 memory pages.

As shown in FIG. 6A, the number of values included in the write protection table 611 is the same as the number of pages. However, according to another exemplary embodiment of the present disclosure, the electronic device may set a single value indicating whether writing is allowed on a plurality of pages. For example, the electronic device may divide the 10 memory pages by 2 pages, thereby getting five groups of memory pages, and then set values indicating whether writing is allowed on each of the five groups. According to another exemplary embodiment of the present disclosure, the electronic device may group the 10 memory pages into groups each including 3 pages, and then set values indicating whether writing is allowed on each of the groups.

In the exemplary embodiment illustrated in FIG. 6A, the values included in the write protection table 611 correspond to the respective pages, and the order of arrangement of the values is the same as the order of arrangement of the pages. However, according to another exemplary embodiment of the present disclosure, the electronic device may set the 10 values, which indicate whether writing is allowed or not, in the write protection table 611 in an order different from the order of the 10 memory pages. For example, the order of the values may be the inverse of the order of the corresponding pages.

In the exemplary embodiment illustrated in FIG. 6A, the values of the write protection table 611 are set as “0” for pages allowed to be written on and set as “1” for pages disallowed to be written on. However, according to another exemplary embodiment of the present disclosure, for the respective memory pages of the write protectable region 605, pages allowed to be written on may be set as “1” and pages disallowed to be written on may be set as “0.”

Referring to FIG. 6B, according to another exemplary embodiment of the present disclosure, the electronic device may set whether to allow access to each of the plurality of memory pages of the security protectable region 607. For example, the electronic device may generate a secure read table 615 in which, for the plurality of memory pages of the security protectable region 607, pages allowed to be secure read are set as “0”, and pages disallowed to be secure read are set as “1.” In addition, the electronic device may generate a secure write table 617 in which, for the plurality of memory pages of the security protectable region 607, pages allowed to be secure written on are set as “0”, and pages disallowed to be written on are set as “1.”

Referring to FIG. 6C, according to another exemplary embodiment of the present disclosure, the electronic device may generate the secure read table 615, the secure write table 617, a normal read table 619, and a normal write table 621 for the plurality of pages of the security protectable region 607. For example, the electronic device may set the normal read 619 and the normal write 621 not to be allowed for the plurality of pages of the security protectable region 607. For example, the electronic device may set all of the values of the normal read table 619 and the normal write table 621 to “0” for the plurality of pages of the security protectable region 607.

According to an exemplary embodiment, the security-related tables 611-617 in FIGS. 6A to 6C have values corresponding to the respective units in the protection regions 605 and 607. However, according to another exemplary embodiment of the present disclosure, the security-related tables 611-617 may have values corresponding to only some of the units of the protection regions 605 and 607. For example, the electronic device may set security only for some regions of the memory regions.

According to an exemplary embodiment, the security-related tables 611-617 may be generated when the electronic device is booted. The electronic device may include a plurality of memories including a first memory and a second memory. The security-related tables 611-617 may be stored in at least one of the plurality of memories. According to another exemplary embodiment of the present disclosure, the security-related tables 611-617 may be loaded from the first memory when the electronic device is booted, and may be stored in the second memory and then may be locked in the second memory. The second memory may be at least one of an SRAM, a scratchpad memory, and an internal memory.

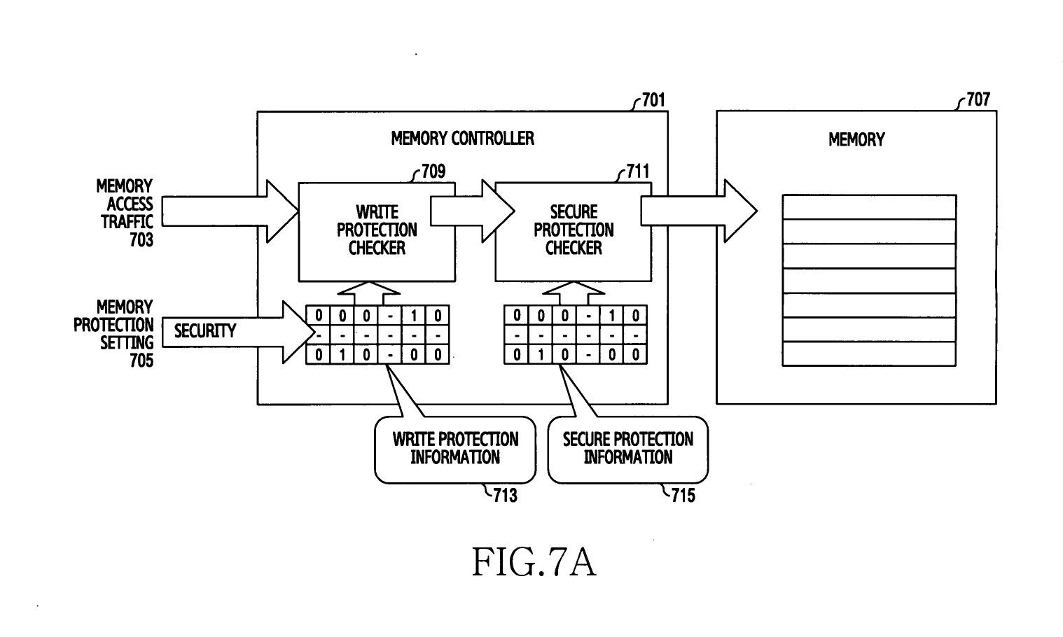

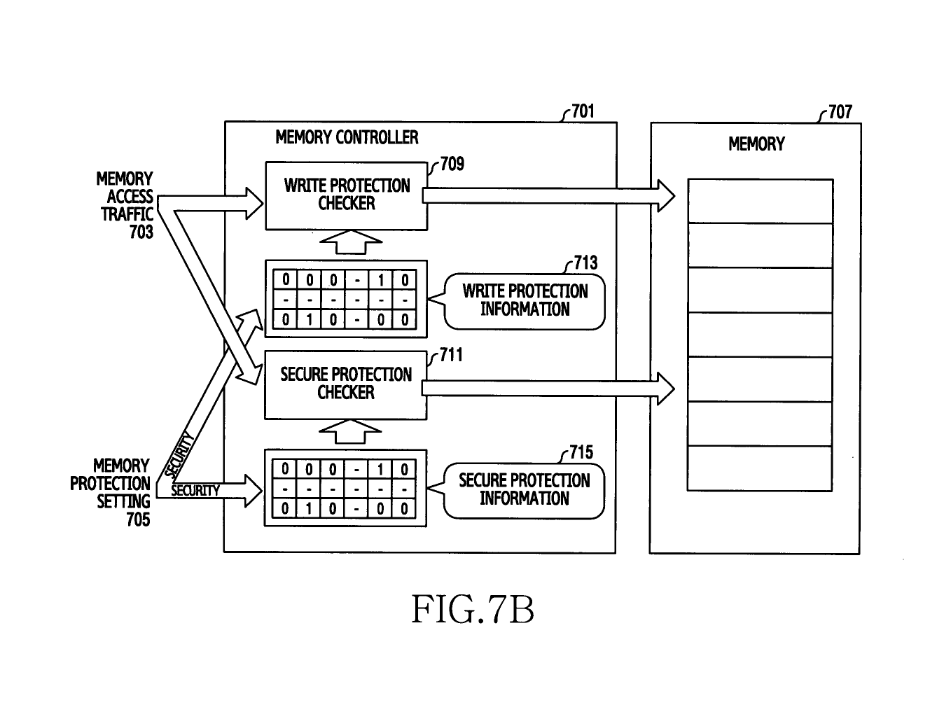

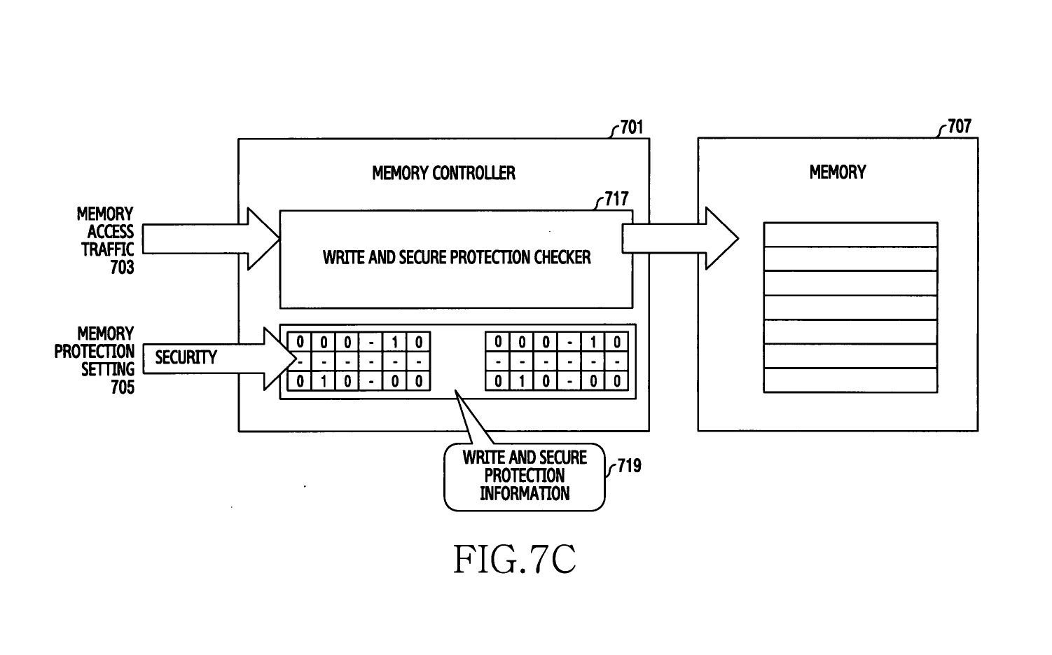

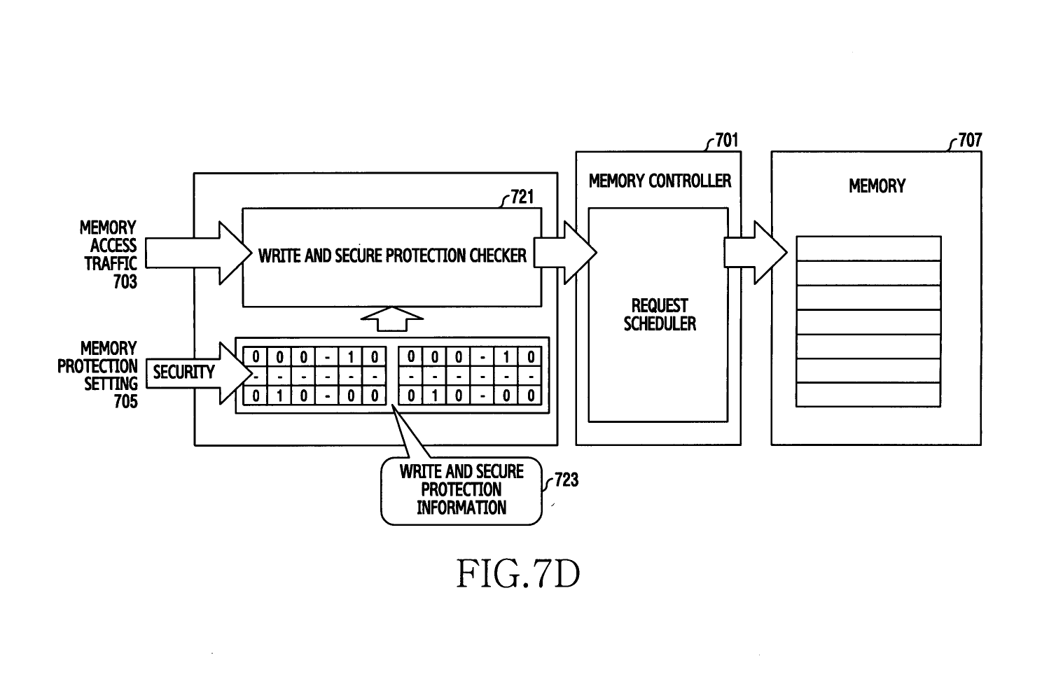

FIGS. 7A to 7D illustrate an example of controlling traffic requesting access to a memory in the electronic device according to the present disclosure.

Referring to FIG. 7A, when traffic 703 trying to access a memory is generated in the electronic device, a memory controller 701 may check security on the traffic 703 through a write protection checker 709. For example, the write protection checker 709 may receive write protection information 713 from a security operation system (not shown). The write protection information 713 may be a memory page table indicating whether access to each of the memory pages of the write protectable region is allowed or not. The memory page table may be set by the security operation system (not shown) (such as 705).

When the traffic 703 passes the check of the write protection checker 709, a secure protection checker 711 may check the traffic 703. For example, the secure protection checker 711 may receive secure protection information 715 from the security operation system (not shown). The secure protection information 715 may be a memory page table indicating whether access to each of the memory pages of the security protectable region is allowed or not. The memory page table may be set by the security operation system (not shown) (705).

The memory controller 701 may determine the security of the traffic 703 by passing through the write protection checker 709 and the secure protection checker 711 in sequence. The memory controller 701 may control the traffic 703 trying to access the memory 707 based on the determined security of the traffic 703.

According to another exemplary embodiment, the locations of the write protection checker 709 and the secure protection checker 711 may vary. For example, the secure protection checker 711 may be located ahead of the write protection checker 709. In addition, the write protection checker 709 and the secure protection checker 711 may not be located in sequence as shown in FIG. 7A, and may be located in parallel. For example, referring to FIG. 7B, the memory access traffic 703 may pass through the write protection checker 709 and the secure protection checker 711 located in parallel. The write protection checker 709 and the secure protection checker 711 may determine whether the memory access traffic 703 is allowed to access the memory 707 or not.

Referring to FIG. 7C, according to another exemplary embodiment of the present disclosure, the write protection checker 709 and the secure protection checker 715 may not be separated and may be integrated into a single checker and operated. For example, the traffic 703 trying to access the memory may not pass through the write protection checker 709 and the secure protection checker 711 in sequence, and may be checked regarding security by simply passing through a write and secure protection checker 717. For example, the write and secure protection checker 717 may receive write and secure protection information 719 from the security operation system (not shown). The write and secure protection checker 717 may determine whether to allow the traffic 703 to access the memory based on the write and secure protection information 719. The write and secure protection information 719 may be a memory page table indicating whether access to each of the plurality of memory pages of the write protectable region and the security protectable region of the memory 707 is allowed or not. The memory page table may be set by the security operation system (not shown) (705).

Referring to FIG. 7D, according to another exemplary embodiment of the present disclosure, a write and secure protection checker 721 may be located outside the memory controller 701. For example, when the traffic 703 trying to access the memory 707 is generated, the traffic 703 may be checked regarding access to the memory 707 by the write and secure protection checker 721 located outside the memory controller 701. The traffic 703 may be checked by the write and secure protection checker 721 and then moved to the memory controller 701.

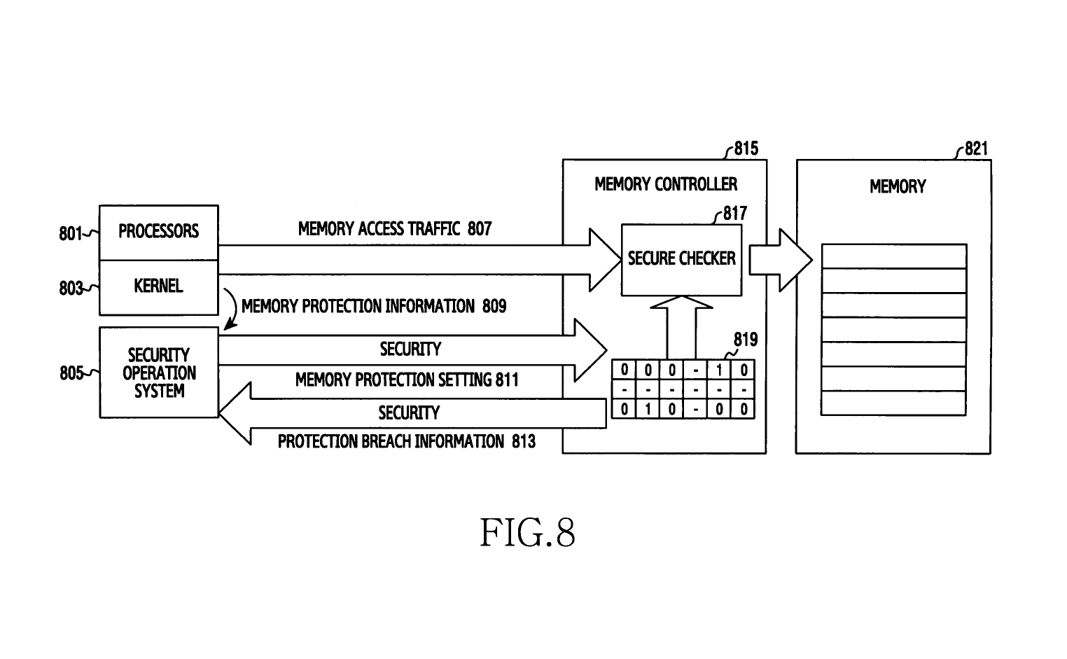

FIG. 8 illustrates an example of, when traffic requesting access to a memory is generated in the electronic device, determining whether the traffic is allowed to access the memory according to the present disclosure.

Referring to FIG. 8, in the electronic device, a kernel 803 may divide the memory 821 into at least one of a reserved region, a write protectable region, a security protectable region, and a normal area which does not require security. The kernel 803 may divide the at least one of the reserved region, the write protectable region, the security protectable region, and the normal region which does not require the security into a plurality of memory pages.

The kernel 803 may set security for each of the memory pages of at least one of the write protectable region and the security protectable region. The kernel 803 may generate memory protection information 809 including information on the security set for each of the memory pages. For example, the memory protection information 809 may be a table 819 in which, for the plurality of memory pages, “0” is set for pages allowed to be accessed and “1” is set for pages disallowed to be accessed.

The kernel 803 may transmit the memory protection information 809 to a security operation system 805. The security operation system 805 may transmit the memory protection information 809 to a protection checker 817 of a memory controller 815. According to another exemplary embodiment of the present disclosure, the protection checker 817 may be located outside the memory controller 815.

When traffic 807 trying to access the memory 821 is generated from at least one processor 801, the protection checker 817 may determine whether the page region of the memory 821 that the traffic 807 tries to access is a memory page allowed to be accessed or not based on the memory protection information 809 or the memory page table 819 which is received from the security operation system 805. When the page region of the memory 821 that the traffic 807 tries to access is the memory page allowed to be accessed, the protection checker 817 may allow the traffic 807 to access. When the page region of the memory 821 that the traffic 807 tries to access is not the memory page allowed to be accessed, the protection checker 817 may block the access of the traffic 807. In addition, the protection checker 817 may inform the security operation system 805 that the traffic trying to access the memory page region disallowed to be accessed has been generated.

The security operation system 805 may manage the memory protection information 809 received from the kernel 803. For example, the security operation system 805 may initialize the memory protection information 809. In addition, when the settings on the memory protection information 809 are requested to be changed by the memory controller 815, the security operation system 805 may change the memory protection information 809 according to the request. For example, when the memory protection information 809 is the memory page table 819, the security operation system 805 may change the information of the memory page table 819 indicating whether access to the memory pages is allowed or not.

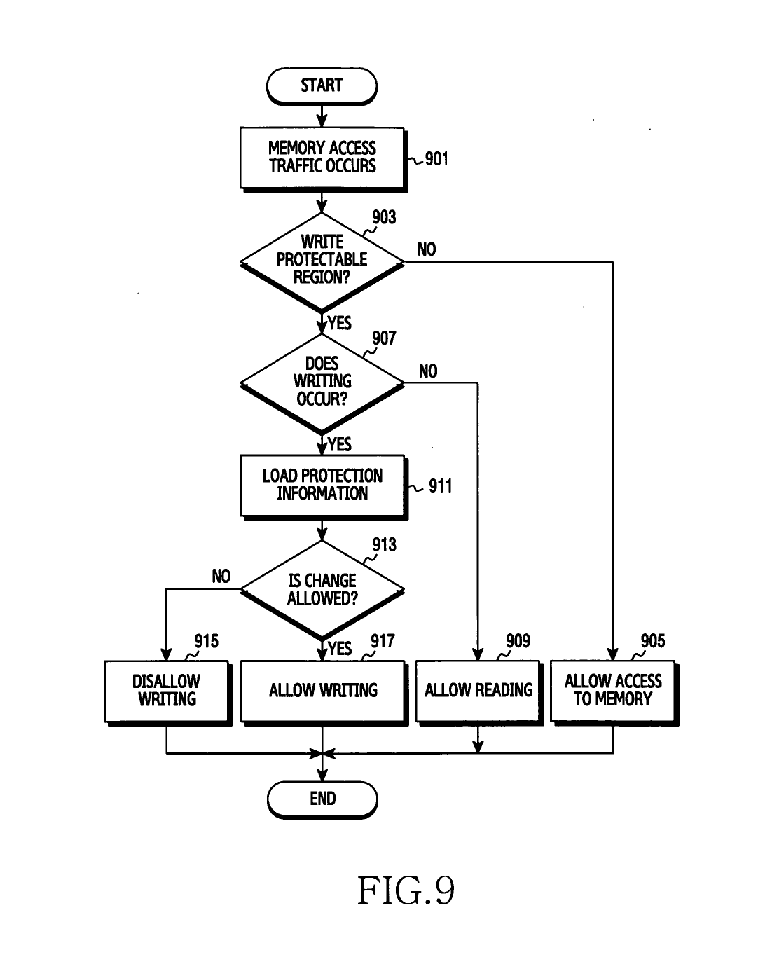

FIG. 9 illustrates an example operation sequence when traffic trying to access a write protectable region of memory regions is generated in the electronic device according to an exemplary embodiment of the present disclosure.

Referring to FIG. 9, the electronic device proceeds to step 901 to recognize generation of traffic trying to access the memory. The electronic device may recognize the generation of the traffic trying to access the memory from at least one processor.

The electronic device proceeds to step 903 to determine whether the traffic is traffic trying to access the write protectable region or not. The electronic device may determine whether the traffic is traffic trying to access the write protectable region of the regions of the memory. When the traffic is not the traffic trying to access the write protectable region, the electronic device proceeds to step 905 to allow the traffic to access the memory.

When the traffic is the traffic trying to access the write protectable region, the electronic device proceeds to step 907 to determine whether writing occurs on a memory page of the write protectable region. When the writing does not occur on the memory page, the electronic device proceeds to step 909 to allow reading from the memory page.

According to another exemplary embodiment of the present disclosure, the electronic device may determine whether the region that the traffic tries to access is the security protectable region or the write protectable region in a different order from the order illustrated in FIG. 9. According to another exemplary embodiment of the present disclosure, the electronic device may determine whether the region that the traffic tries to access is the security protectable region or the write protectable region simultaneously.

When writing occurs on at least one page of the write protectable region, the electronic device proceeds to step 911 to load protection information on the corresponding page. When writing occurs on the at least one page, the electronic device may identify information on the corresponding page in the memory protection information on the write protectable region. The memory protection information is a bit stream displaying information on whether access to each of the pages of the write protectable region is allowed or not.

The electronic device proceeds to step 913 to determine whether a change to the at least one memory page of the write protectable region is allowed or not. When the writing occurs on the at least one memory page, the electronic device may determine whether the at least one memory page is allowed to be written on or not based on the memory protection information. When the at least one memory page is a memory page disallowed to be written on, the electronic device proceeds to step 915 to disregard the writing input and inform the system that an exceptional circumstance has arisen. When the memory page is a memory page allowed to be written on, the electronic device proceeds to step 917 to allow the writing on the memory page.

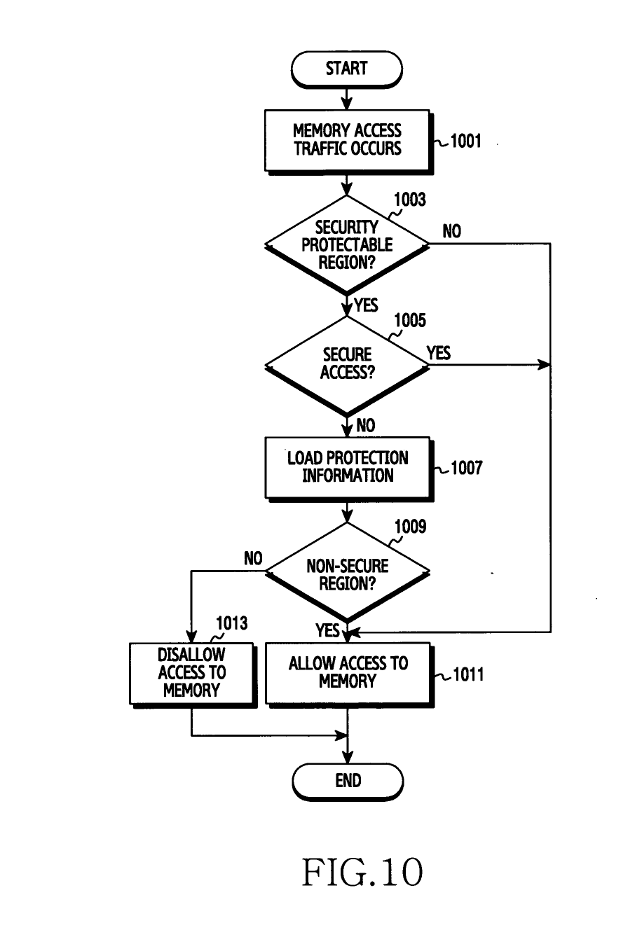

FIG. 10 illustrates another example operation sequence when traffic trying to access a security protectable region of regions of a memory is generated in the electronic device according to an exemplary embodiment of the present disclosure.

Referring to FIG. 10, the electronic device proceeds to step 1001 to recognize generation of traffic trying to access the memory. The electronic device may recognize the generation of the traffic trying to access the memory from at least one processor.

The electronic device proceeds to step 1003 to determine whether the traffic is traffic trying to access the security protectable region or not. When the traffic is not the traffic trying to access the security protectable region, the electronic device proceeds to step 1011 to allow the traffic to access the memory.

When the traffic is the traffic trying to access the security protectable region, the electronic device proceeds to step 1005 to determine whether the traffic is traffic allowed to access the security protectable region or not. When the traffic is the traffic allowed to access the security protectable region, the electronic device proceeds to step 1011 to allow the traffic to access the security protectable region.

According to another exemplary embodiment of the present disclosure, the electronic device may determine whether the traffic tries to access the security protectable region or the write protectable region in a different order from the order illustrated FIG. 10, or may determine simultaneously.

When the traffic tries to access the security protectable region, but the access is non-secure access, the electronic device proceeds to step 1007 to load secure protection information of the memory. The memory protection information is bit stream recording information on whether secure protection is needed for each of the pages of the security protectable region.

The electronic device proceeds to step 1009 to determine whether the page of the security protectable region that the traffic tries to access is a non-secure page or a secure page. The electronic device may determine whether the memory page that the traffic tries to access is a secure region disallowing non-secure access or a non-secure region allowing access. When the memory page is the non-secure region, the electronic device proceeds to step 1011 to allow the traffic to access the memory page.

When the memory page is not the non-secure region, the electronic device proceeds to step 1013 to disallow the access of the traffic and informs the system that an exceptional circumstance has arisen.

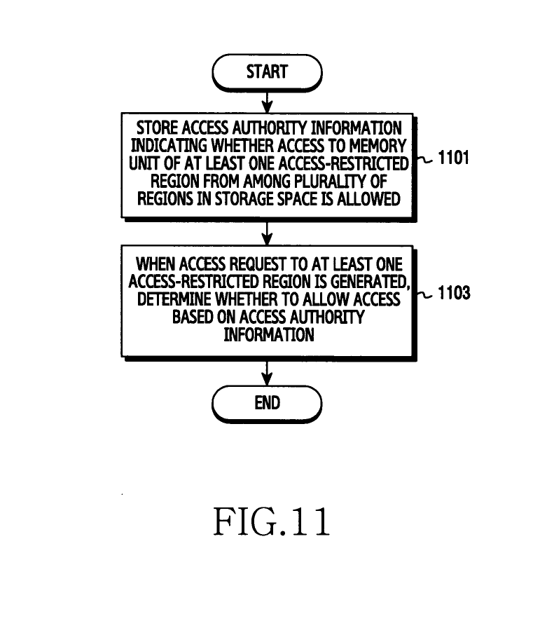

FIG. 11 illustrates another example operation sequence of the electronic device according to an exemplary embodiment of the present disclosure.

Referring to FIG. 11, the electronic device proceeds to step 1101 to store access authority information indicating whether access to each of memory units of at least one access-restricted region from among a plurality of regions in a storage space is allowed or not. The access authority information may include at least one table for each of the at least one access-restricted region. The table may indicate whether at least one of secure read, secure write, normal read, and normal write is allowed or not for each of the memory units. The electronic device may store the access authority information in the at least one access-restricted region.

The electronic device proceeds to step 1103 to determine whether to allow access or not based on the access authority information when a request to access the at least one access-restricted region is generated. The access request may include a display indicating that the intention of the access request is for at least one of secure read, secure write, normal read, and normal write on the at least one memory unit, and an address of a memory unit that the access request tries to access. When the memory unit to which the access request is generated is a memory unit disallowing the intention of the access request, the electronic device may block the access request. When a change to the access authority information is requested, the electronic device may change the access authority information. The at least one access-restricted region may include a region restring at least one of read and write. When a request to access the region restricting at least one of the read and the writ is generated, the electronic device may determine whether to allow the access based on the access authority information.

According to various exemplary embodiments of the present disclosure, an operation method of an electronic device may include: storing access authority information indicating whether access to each of memory units of at least one access-restricted region from among a plurality of regions in a storage space is allowed or not; and, when an access request to the at least one access-restricted region is generated, determining whether to allow access based on the access authority information.

According to various exemplary embodiments of the present disclosure, the access authority information may include at least one table for each of the at least one access-restricted region, and each of the at least one table may indicate whether at least one of secure read, secure write, normal read, and normal write is allowed on each of the memory units.

According to various exemplary embodiments of the present disclosure, the access request may include a display indicating that the access request has an intention of performing at least one of secure read, secure write, normal read, and normal write on the at least one memory unit, and an address of a memory unit that the access request tires to access.

According to various exemplary embodiments of the present disclosure, the determining whether to allow the access may include, when the memory unit to which the access request is generated is a memory unit which does not allow the intention of the access request, blocking the access request.

According to various exemplary embodiments of the present disclosure, the operation method may further include, when a change to the access authority information is requested, changing the access authority information.

According to various exemplary embodiments of the present disclosure, the storing the access authority information may include storing the access authority information in the at least one access-restricted region.

According to various exemplary embodiments of the present disclosure, the at least one access-restricted region may include a region which restricts at least one of read and write.

According to various exemplary embodiments of the present disclosure, the determining whether to allow the access may include, when an access request to the region restricting at least one of the read and the write is generated, determining whether to allow the access based on the access authority information.

Methods based on the embodiments disclosed in the claims and/or specification of the present disclosure may be implemented in hardware, software, or a combination of hardware and software.

When implemented in software, a computer readable recording medium for storing one or more programs (software modules) may be provided. The one or more programs stored in the computer readable recording medium are configured for execution performed by one or more processors in an electronic device. The one or more programs include instructions for allowing the electronic device to execute the methods based on the embodiments disclosed in the claims or specification of the present disclosure.

The program (software module or software) may be stored in a random access memory, a non-volatile memory including a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a Local Area Network (LAN), a Wide LAN (WLAN), or a Storage Area Network (SAN) or a communication network configured by combining the networks. The storage device may access via an external port to the apparatus performing the exemplary embodiments of the present disclosure. In addition, a separate storage device on the communication network may access the apparatus performing the exemplary embodiments of the present disclosure.

In the exemplary embodiments of the present disclosure described above, the elements included in the present disclosure are expressed in a singular form or a plural form according to an exemplary embodiment. However, the singular form or plural form is just selected to suit to a suggested situation for the sake of easy explanation, and the present disclosure is not limited to the single or plural elements. Even when an element is expressed in a plural form, the element may be provided as a single element, and, even when an element is expressed in a singular form, the element may be provided as a plurality of elements.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a memory configured to store access authority information indicating whether access to each of memory units of at least one access-restricted region from among a plurality of regions in a storage space is allowed or not; and
a memory controller configured to, when an access request to the at least one access-restricted region is generated, determine whether to allow access based on the access authority information.

2. The electronic device of claim 1, wherein the access authority information comprises at least one table for each of the at least one access-restricted region, and
wherein each of the at least one table indicates whether at least one of secure read, secure write, normal read, or normal write is allowed on each of the memory units.

3. The electronic device of claim 1, wherein the access request comprises a display indicating that the access request has an intention of performing at least one of secure read, secure write, normal read, or normal write on at least one of the memory units, and an address of the at least one the memory unit that has the access request trial to access.

4. The electronic device of claim 3, wherein, when the memory unit to which the access request is generated is a memory unit that does not allow the intention of the access request, the memory controller is configured to block the access request.

5. The electronic device of claim 1, wherein, when a change to the access authority information is requested, the memory controller is configured to change the access authority information.

6. The electronic device of claim 1, wherein the memory is configured to store the access authority information in the at least one access-restricted region.

7. The electronic device of claim 1, wherein the at least one access-restricted region comprises a region that restricts at least one of read or write.

8. The electronic device of claim 7, wherein, when an access request to the region restricting at least one of the read or the write is generated, the memory controller is configured to determine whether to allow the access based on the access authority information.

9. A method of operating an electronic device, the method comprising:
storing access authority information indicating whether access to each of memory units of at least one access-restricted region from among a plurality of regions in a storage space is allowed or not; and
when an access request to the at least one access-restricted region is generated, determining whether to allow access based on the access authority information.

10. The method of claim 9, wherein the access authority information comprises at least one table for each of the at least one access-restricted region, and
wherein each of the at least one table indicates whether at least one of secure read, secure write, normal read, or normal write is allowed on each of the memory units.

11. The method of claim 9, wherein the access request comprises a display indicating that the access request has an intention of performing at least one of secure read, secure write, normal read, or normal write on at least one of the memory units, and an address of at least one of the memory unit that has the access request trial to access.

12. The method of claim 11, further comprising: when the memory unit to which the access request is generated is a memory unit that does not allow the intention of the access request, blocking the access request.

13. The method of claim 9, further comprising, when a change to the access authority information is requested, changing the access authority information.

14. The method of claim 9, wherein the access authority information comprises storing the access authority information in the at least one access-restricted region.

15. The method of claim 9, wherein the at least one access-restricted region comprises a region that restricts at least one of read or write.

16. The method of claim 15, further comprising when an access request to the region restricting at least one of the read or the write is generated, determining whether to allow the access based on the access authority information.
